(19) United States
(12) Patent Application Publication
(10) Pub. No.: US 2014/0059361 A1
(43) Pub. Date: Feb. 27, 2014

(54) INFORMATION PROCESSING SYSTEM, EXTERNAL APPARATUS, AND METHOD FOR SUPPLYING POWER FROM HOST APPARATUS TO EXTERNAL APPARATUS

(71) Applicant: Buffalo Inc., Nagoya-shi (JP)

(72) Inventor: Kazutoshi TAJIMA, Nagoya-shi (JP)

(73) Assignee: Buffalo Inc., Nagoya-shi (JP)

(21) Appl. No.: 14/010,053

(22) Filed: Aug. 26, 2013

(30) Foreign Application Priority Data
Aug. 27, 2012 (JP) 2012-186268

(51) Int. Cl. G06F 1/26

(52) U.S. Cl. CPC G06F 1/266
USPC 713/300

(57) ABSTRACT

An information processing apparatus including a first external interface configured to be connected to a host apparatus, a first power supply section configured to be connected to an external power supply and a second power supply section configured to receive power via the first external interface. The information processing apparatus configured to detect whether power is received at the first power supply section; and declare, to the host apparatus, a maximum current value equal to or smaller than a prescribed maximum current value defined by the host apparatus when the information processing apparatus is connected to the host apparatus via the first external interface and it is detected that power is received at the first power supply section.

### CROSS REFERENCE TO RELATED APPLICATION

This non-provisional application claims priority under 35 U.S.C. §119(a) on Patent Application No. 2012-186268 filed in Japan on Aug. 27, 2012, the entire contents of which are hereby incorporated by reference.

### FIELD OF THE DISCLOSURE

A one aspect of the present disclosure relates to an information processing system composed of host apparatus and external apparatus mutually connected via an external interface.

### RELATED ART

In the universal serial bus (USB) standard, which is one example of external interfaces generally known, there are the following types of USB device connected to a USB host: device driven by an internal power supply possessed by the USB device itself or an external power supply connected to the USB device (self-powered device); and device driven by power supplied from the USB host (bus-powered device).

In the USB 2.0 standard, as power supplied from a USB host to a bus-powered device, the voltage is 5 V and the maximum current is 100 mA for a low-power device and 500 mA for a high-power device. Originally the USB standard is made in order to connect peripheral apparatus such as mouse and keyboard and therefore its power feed capability is not high compared with other external interfaces (e.g. Thunderbolt (registered trademark)).

In the USB standard, a USB device can declare the maximum value of the current with which the USB device desires to be supplied, when the USB device is connected to a USB host. Specifically, the USB device can declare the maximum current value in the MaxPower field in the configuration descriptor, which is a parameter in communication between the USB device and the USB host when the USB device is connected to the USB host. The USB host interprets the maximum current value declared from the USB device and often permits a connection (mounts the USB device) only when this maximum current value is equal to or smaller than the value defined in the USB standard or a prescribed maximum current value that is uniquely defined by the controller of the USB host and is smaller than the maximum value of the USB standard. This is because the circuit of the controller of the USB host is often designed based on the premise that the controller allows supply of a current equal to or smaller than the maximum current value of the USB standard or the prescribed maximum current value unique to the USB host.

In recent years, as a wireless communication device typified by the smartphone, such a device is realized that a USB device is connected to a USB interface provided in the wireless communication device and data transmission and reception in conformity with the USB standard can be performed between these wireless communication device and USB device like e.g. the USB On-The-Go (USB OTG) and connection handling of the USB mass storage class. Normally such a wireless communication device is driven by an internal power supply such as a battery possessed by the wireless communication device itself and therefore tends to avoid supply of a large current to a USB device for a long time compared with the USB host, which is a personal computer (PC) in many cases. This is because supply of a large current to the USB device for a long time possibly causes a sudden decrease in the remaining power level of the internal power supply of the wireless communication device and shortens the driving time of the wireless communication device itself. Therefore, in such a wireless communication device, the above-described prescribed maximum current value is often set to a value smaller than the maximum current value of the USB standard, specifically to 200 mA as one example.

This prescribed maximum current value is uniform irrespective of whether the USB device is self-powered or bus-powered. This is because of the following reason. Specifically, in some cases, a USB device that is originally a self-powered device is switched to a bus-powered device because of e.g. the lowering of the remaining capacity of the internal power supply possessed by this USB device. So, the prescribed maximum current value is set uniform in order to prevent a situation in which the USB device cannot be connected in this case. Therefore, a USB device that is a self-powered device and consumes a current equal to or larger than 200 mA, specifically e.g. a portable hard disk drive (HDD) device in a state of being connected to an alternating-current (AC) adapter, has a possibility of not being permitted to be connected (mounted) by a wireless communication device although the USB device can cover its power supply by itself.

As a related art, the following technique has been disclosed (refer to Japanese Patent Laid-open No. 2010-140269). Specifically, under a condition in which the maximum current value permitted for the self-powered device is smaller than the maximum current value permitted for the bus-powered device, a terminal device that is a self-powered device declares, to the USB host, that the terminal device is a bus-powered device, and thereby obtains supply of power with the maximum current value permitted for the bus-powered device from the USB host.

However, the above-described related-art terminal device is based on the premise that the maximum current value permitted for the bus-powered device is equal to or larger than the maximum current value permitted for the self-powered device, and therefore has the following problem. Specifically, if a USB host limits the maximum current value to the prescribed maximum current value even for the self-powered device like the above-described wireless communication device, a self-powered device that consumes a current equal to or larger than the prescribed maximum current value is not permitted to be connected by the USB host as a result.

The present disclosure is made in view of the above-described problem and one of objects thereof is to provide an information processing system allowing external apparatus that consumes a current equal to or larger than a prescribed maximum current value defined by host apparatus to be surely connected to the host apparatus, and provide external apparatus and a method for supplying power from host apparatus to external apparatus.

### SUMMARY

According to one exemplary embodiment, the disclosure is directed to an information processing apparatus including a first external interface configured to be connected to a host apparatus, a first power supply section configured to be connected to an external power supply and a second power supply section configured to receive power via the first external interface. The information processing apparatus configured to detect whether power is received at the first power supply section; and declare, to the host apparatus, a maximum current value equal to or smaller than a prescribed maximum current value defined by the host apparatus when the information processing apparatus is connected to the host apparatus via the first external interface and it is detected that power is received at the first power supply section.

### BRIEF DESCRIPTION OF DRAWINGS

FIG. 1 is a schematic diagram showing the outline of an information processing system according to one aspect of an embodiment of the present disclosure;

FIG. 2 is a block diagram showing the schematic configuration of a wireless communication device used for the information processing system according to one aspect of the present embodiment;

FIG. 3 is a block diagram showing the schematic configuration of a control device used for the information processing system according to one aspect of the present embodiment;

FIG. 4 is a functional block diagram showing the functional configuration of the information processing system according to one aspect of the present embodiment;

FIG. 5 is a sequence diagram for explaining one example of the operation of the information processing system according to one aspect of the present embodiment;

FIG. 6 is a sequence diagram for explaining another example of the operation of the information processing system according to one aspect of the present embodiment;

FIG. 7 is a sequence diagram for explaining further example of the operation of the information processing system according to one aspect of the present embodiment;

FIG. 8 is a schematic diagram showing the outline of an information processing system according to another aspect of the embodiment of the present disclosure;

FIG. 9 is a block diagram showing the schematic configuration of a USB device used for the information processing system according to another aspect of the present embodiment; and

FIG. 10 is a functional block diagram showing the functional configuration of the information processing system according to another aspect of the present embodiment.

### DESCRIPTION OF THE DISCLOSURE

An information processing system according to an embodiment of the present disclosure will be described below with reference to the drawings.

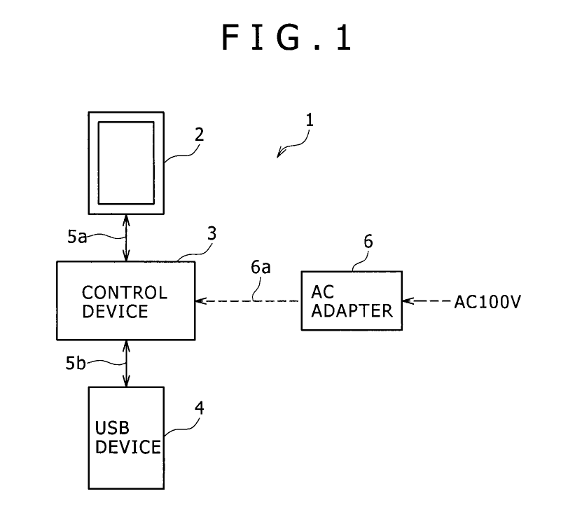

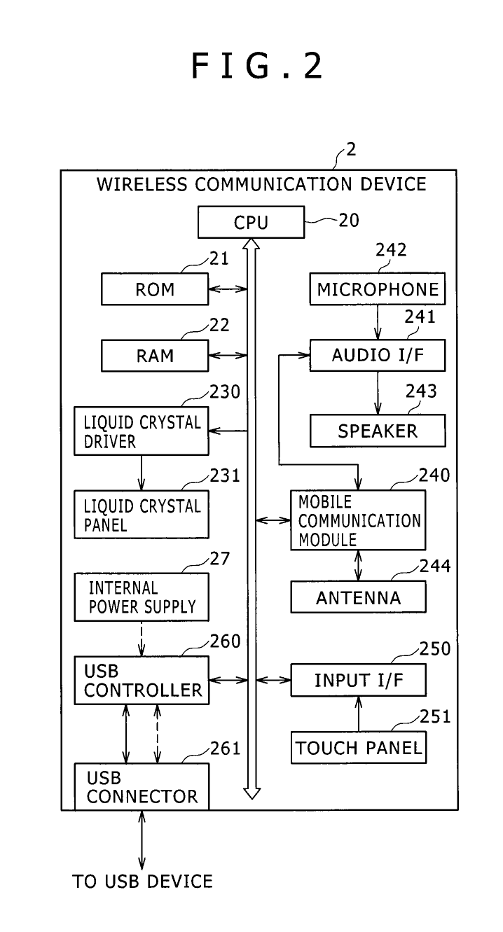

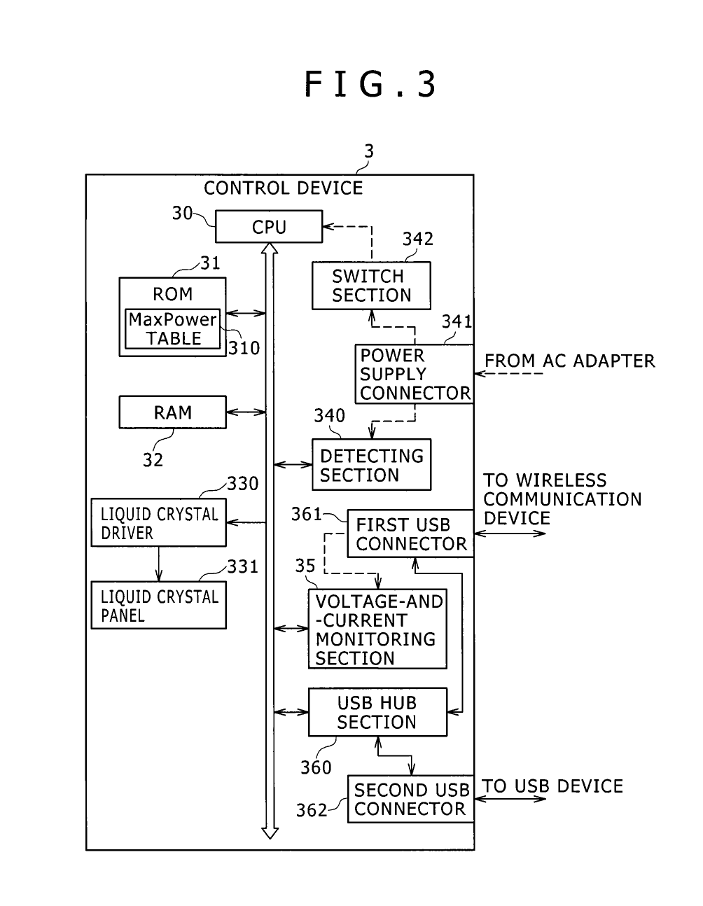

FIG. 1 is a schematic diagram showing the outline of an information processing system according to one aspect of the embodiment of the present disclosure. FIG. 2 is a block diagram showing the schematic configuration of a wireless communication device used for the information processing system according to one aspect of the present embodiment. FIG. 3 is a block diagram showing the schematic configuration of a control device used for the information processing system according to one aspect of the present embodiment.

In these diagrams, numeral 1 denotes the information processing system according to one aspect of the present embodiment. This information processing system 1 has a wireless communication device (host apparatus) 2, a control device (external apparatus) 3, and a USB device (peripheral apparatus) 4. The wireless communication device 2 is a so-called smartphone or the like and allows a voice telephone call via a mobile communication network. The control device 3 carries out control when the USB device 4 is connected to the wireless communication device 2 via external interfaces. The USB device 4 is e.g. a portable hard disk drive (HDD) device and is so configured as to be accessible from the wireless communication device 2 via the control device 3.

These wireless communication device 2, control device 3, and USB device 4 include a USB interface as an external interface (details will be described later), and are each sequentially connected by USB cables 5a and 5b, which allows data transmission and reception among these wireless communication device 2, control device 3, and USB device 4. The control device 3 and the USB device 4 are supplied with power from the wireless communication device 2 via the USB interface. In addition, the control device 3 is supplied with commercial power via an AC adapter 6 by a connection of a power supply cable 6a of the AC adapter 6 to this control device 3. That is, the USB device 4 is a bus-powered device and the control device 3 is both a bus-powered device and a self-powered device.

FIG. 2 is a block diagram showing the schematic configuration of the wireless communication device 2 used for the information processing system 1 according to one aspect of the present embodiment. In FIG. 2, the wireless communication device 2 includes a central processing unit (CPU) 20, a read only memory (ROM) 21, a random access memory (RAM) 22, a liquid crystal driver 230, a liquid crystal panel 231, a mobile communication module 240, an audio interface (I/F) 241, a microphone 242, a speaker 243, an antenna 244, an input interface (I/F) 250, a touch panel 251, and a USB controller 260. The CPU 20, the ROM 21, the RAM 22, the liquid crystal driver 230, the mobile communication module 240, the input interface 250, and the USB controller 260 are connected to each other by a common bus.

A program such as firmware stored in the ROM 21 is expanded in the RAM 22 and then run. Thereby, the CPU 20 controls the operation of the whole of the wireless communication device 2 and operates also as the respective functional sections to be described later. Programs such as the above-described firmware and various kinds of setting data are stored in the ROM 21. The RAM 22 operates as a work memory of the wireless communication device 2 and various kinds of programs and data are temporarily stored therein.

The liquid crystal panel 231 is so provided that its display surface is exposed at a surface of the wireless communication device 2. When being supplied with data configuring a display screen from the CPU 20, the liquid crystal driver 230 drives the liquid crystal panel 231 so that the desired display screen may be displayed on the display surface of the liquid crystal panel 231.

The mobile communication module 240 performs mobile wireless communication with the mobile communication network via the antenna 244 in conformity with e.g. the international mobile telecommunication (IMT)-2000 standard. Specifically, the mobile communication module 240 outputs an audio signal obtained by decoding radio waves received from a base station of the mobile communication network as sound from the speaker 243 via the audio interface 241. Furthermore, the mobile communication module 240 encodes sound collected by the microphone 242 via the audio interface 241 and transmits the sound as radio waves to a base station of the mobile communication network via the antenna 244. The standards with which this mobile communication module 240 is compatible include at least one of the 3rd generation/high-speed downlink packet access (3G/HSDPA), the long term evolution (LTE), and the worldwide interoperability for microwave access (WiMAX).

The touch panel 251 is so provided as to be overlapped on the display surface of the liquid crystal panel 231 in the present embodiment and has substantially the same size as that of the display surface of this liquid crystal panel 231. When the surface of the touch panel 251 is touched by the user, i.e. a specific position on the surface of the touch panel 251 is touched by the user, the specific position on the surface of the touch panel 251 is detected as a two-dimensional coordinate position and this coordinate position is output via the input interface 250.

The USB controller 260 performs data transmission and reception with a USB device connected via a USB connector 261 in accordance with the USB 2.0 or USB 3.0 standard. In particular, the USB controller 260 of the present embodiment is compatible with the USB On-The-Go or has a configuration permitting a connection of the USB mass storage class. When a USB device is connected to the wireless communication device 2, the USB controller 260 temporarily functions as the USB host and controls data transmission and reception with the USB device. In the present embodiment, the prescribed maximum current value with and under which the USB controller 260 permits a connection (mounting) is set to 200 mA for both the bus-powered device and the self-powered device.

The USB connector 261 is a so-called female USB connector (USB receptacle) and is so configured that a male USB connector (USB plug) of the USB cable 5a can be inserted therein. Because the wireless communication device 2 has a small-size chassis in many cases, a so-called Mini-AB or Micro-AB receptacle is employed as the USB connector 261.

The wireless communication device 2 according to one aspect of the present embodiment includes an internal power supply 27 such as a secondary battery and power is supplied from this internal power supply 27 to the whole of the wireless communication device 2. In addition, power is supplied to apparatus (control device 3, in one aspect of the present embodiment) connected to the USB connector 261 via the USB controller 260 and the USB connector 261 when needed.

### Schematic Configuration of Control Device

FIG. 3 is a block diagram showing the schematic configuration of the control device 3 used for the information processing system 1 according to one aspect of the present embodiment. In FIG. 3, the control device 3 includes a CPU 30, a ROM 31, a RAM 32, a liquid crystal driver 330, a liquid crystal panel 331, a detecting section 340, a power supply connector 341, a switch section 342, a voltage-and-current monitoring section 35, a USB hub section 360, a first USB connector 361, and a second USB connector 362. The CPU 30, the ROM 31, the RAM 32, the liquid crystal driver 330, the detecting section 340, the voltage-and-current monitoring section 35, and the USB hub section 360 are connected to each other by a common bus.

A program such as firmware stored in the ROM 31 is expanded in the RAM 32 and then run. Thereby, the CPU 30 controls the operation of the whole of the control device 3 and operates also as the respective functional sections to be described later. The ROM 31 is e.g. a writable ROM such as a flash memory and programs such as the above-described firmware and various kinds of setting data are stored in this ROM 31. The RAM 32 operates as a work memory of the control device 3 and various kinds of programs and data are temporarily stored therein. Furthermore, in the ROM 31, a MaxPower table 310 storing the maximum current value that should be declared to the wireless communication device 2 operating as the USB host is stored.

The liquid crystal panel 331 is so provided that its display surface is exposed at a surface of the control device 3. When being supplied with data configuring a display screen from the CPU 30, the liquid crystal driver 330 drives the liquid crystal panel 331 so that the desired display screen may be displayed on the display surface of the liquid crystal panel 331. The display screen displayed on the liquid crystal panel 331 of the control device 3 is simpler than that in the wireless communication device 2 and a display screen capable of informing the user of the state of the control device 3 (e.g. whether it is a bus-powered device or a self-powered device or whether it has a voltage in the normal range or the voltage has been lowered) is enough as a minimum. Therefore, the liquid crystal panel 331 and the liquid crystal driver 330 may also have a simple configuration compared with that in the wireless communication device 2.

The power supply connector 341 is so configured that the power supply cable 6a of the above-described AC adapter 6 (see FIG. 1) can be connected thereto and DC power with a predetermined voltage (e.g. 5 V) is supplied from this AC adapter 6. The detecting section 340 monitors the supply voltage input to this power supply connector 341. Upon detecting supply of DC power with a predetermined voltage to the power supply connector 341 or disconnection of DC power supplied to the power supply connector 341, the detecting section 340 notifies the CPU 30 and so forth of this detection result. The switch section 342 also monitors the supply voltage input to the power supply connector 341. Upon detecting supply of DC power with a predetermined voltage to the power supply connector 341, the switch section 342 sends out, to the CPU 30, an instruction to switch the power for driving the whole of the control device 3 from power supplied from the USB host (wireless communication device 2, in one aspect of the present embodiment) to power supplied from the AC adapter 6. On the other hand, upon detecting disconnection of DC power supplied to the power supply connector 341, the switch section 342 sends out, to the CPU 30, an instruction to switch the power for driving the whole of the control device 3 from power supplied from the AC adapter 6 to power supplied from the USB host (wireless communication device 2, in one aspect of the present embodiment). That is, the switch section 342 makes an instruction for switching between a bus-powered device and a self-powered device. The instruction from the switch section 342 is input to a general purpose input/output (GPIO) port of the CPU 30. The switch section 342 can be configured by e.g. a field effect transistor (FET).

Both the first USB connector 361 and the second USB connector 362 are a female USB connector (USB receptacle). They are so configured that a male USB connector (USB plug) of the USB cable 5a can be inserted in the first USB connector 361 and a male USB connector (USB plug) of the USB cable 5b can be inserted in the second USB connector 362.

The voltage-and-current monitoring section 35 monitors the voltage and current of the power supplied from the wireless communication device 2 via the first USB connector 361 and reports the detection result to the CPU 30 and so forth.

The USB hub section 360 includes a so-called USB hub controller chip. The upstream port of the USB hub section 360 is connected to the first USB connector 361 and the downstream port is connected to the second USB connector 362. Although only one connector (second USB connector 362) is connected to the downstream port in the present embodiment, the number of connectors provided on the downstream port side is not limited to one. The USB hub section 360 performs establishment and disconnection of a USB connection between the first USB connector 361 on the upstream port side and the second USB connector 362 on the downstream port side, detection of attachment/detachment of a USB device connected to the USB connector 361 or 362, protocol processing necessary for USB communication, status management of the ports, and so forth. Furthermore, this USB hub section 360 supplies the power of the control device 3 supplied from either the power supply connector 341 or the first USB connector 361 to a device (USB device 4, in the present embodiment) connected to the downstream port side via the second USB connector 362. Moreover, when the control device 3 is operating as a self-powered device, this USB hub section 360 does not send out, to the second USB connector 362, the Get Descriptor command among commands sent out from the wireless communication device 2 operating as the USB host, and interprets the commands in the control device 3 to return a proper command. Details of this operation will be described later.

### Functional Configuration of Information Processing System

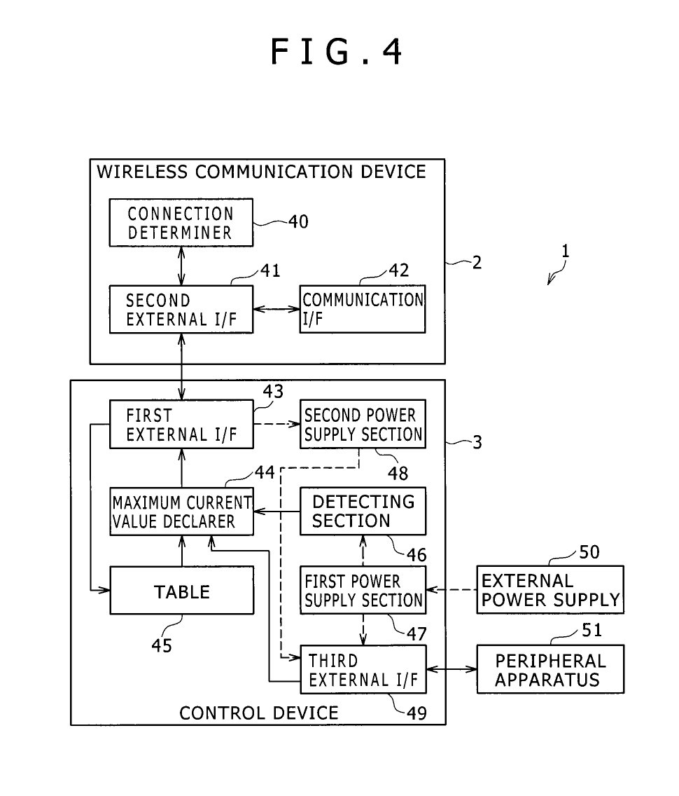

FIG. 4 is a functional block diagram showing the functional configuration of the information processing system 1 according to one aspect of the present embodiment. In FIG. 4, the wireless communication device 2 configuring the information processing system 1 includes a connection determiner 40, a second external interface (I/F) 41, and a communication interface (I/F) 42. The control device 3 includes a first external interface 43, a maximum current value declarer 44, a table 45, a detecting section 46, a first power supply section 47, a second power supply section 48, and a third external interface 49.

The connection determiner 40 retains a prescribed maximum current value for determination as to whether or not to permit a connection to the wireless communication device 2. The connection determiner 40 compares the prescribed maximum current value with the maximum current value declared by external apparatus including the control device 3 connected to the wireless communication device 2 via the second external interface 41, and permits a connection to this wireless communication device 2 if the maximum current value is equal to or smaller than the prescribed maximum current value. In the present embodiment, this prescribed maximum current value is set to 200 mA as described above.

The second external interface 41 performs data transmission and reception with the external apparatus including the control device 3 connected to the wireless communication device 2 based on the USB standard in one aspect of the present embodiment. The communication interface 42 connects an external network such as the Internet via the mobile communication network in one aspect of the present embodiment and performs data transmission and reception with the external network. In particular, the communication interface 42 of one aspect of the present embodiment enables data transmission and reception between the external apparatus including the control device 3 and the external network via the first external interface 43 and the second external interface 41.

The first external interface 43 performs data transmission and reception with host apparatus including the wireless communication device 2 connected to the control device 3 based on the USB standard in one aspect of the present embodiment. Similarly, the third external interface 49 performs data transmission and reception with peripheral apparatus 51 including the USB device 4 connected to the control device 3 based on the USB standard in one aspect of the present embodiment. In addition, the third external interface 49 supplies power to the peripheral apparatus 51 including the USB device 4 connected to the control device 3. When the control device 3 is connected to the host apparatus including the wireless communication device 2 via the first external interface 43 and the second external interface 41, the maximum current value declarer 44 declares the maximum current value that can be supplied from the host apparatus to this host apparatus. In the table 45, the maximum current value that should be declared by the maximum current value declarer 44 is stored. The maximum current value declarer 44 refers to this maximum current value stored in the table 45 to declare the maximum current value to the host apparatus. This maximum current value stored in the table 45 includes a maximum current value presumed in advance to be equal to or smaller than the prescribed maximum current value defined by the host apparatus.

An external power supply 50 is connected to the first power supply section 47 and the control device 3 is driven by power supplied from this external power supply 50. The detecting section 46 detects whether or not power is being supplied from the external power supply 50 to this first power supply section 47. If the detecting section 46 detects that power is being supplied from the external power supply 50 to this first power supply section 47, the maximum current value declarer 44 declares, to the host apparatus, a maximum current value equal to or smaller than the prescribed maximum current value defined by the host apparatus including the wireless communication device 2. If the detecting section 46 does not detect that power is being supplied from the external power supply 50 to this first power supply section 47, the maximum current value declarer 44 declares the maximum current value declared by the peripheral apparatus 51 including the USB device 4 to the host apparatus including the wireless communication device 2. To the second power supply section 48, power is supplied from the wireless communication device 2 via the first external interface 43.

In the above-described functional configuration, the connection determiner 40 is configured mainly by the CPU 20. The second external interface 41 is configured mainly by the CPU 20 and the USB controller 260. The communication interface 42 is configured mainly by the CPU 20 and the mobile communication module 240. The first external interface 43 is configured mainly by the CPU 30, the USB hub section 360, and the first USB connector 361. The maximum current value declarer 44 is configured mainly by the CPU 30. The table 45 is configured mainly by the MaxPower table 310 of the ROM 31. The detecting section 46 is configured mainly by the CPU 30 and the detecting section 340. The first power supply section 47 is configured mainly by the power supply connector 341. The second power supply section 48 is configured mainly by the first USB connector 361. The third external interface 49 is configured mainly by the CPU 30, the USB hub section 360, and the second USB connector 362. The external power supply 50 is configured mainly by the AC adapter 6.

### Operation of Information Processing System

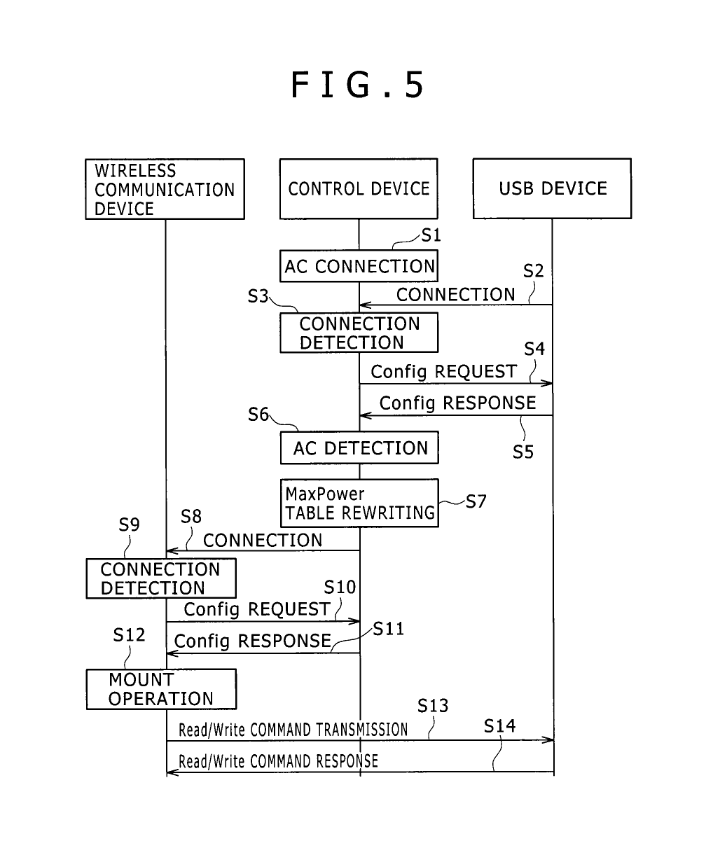

The operation of the information processing system 1 according to one aspect of the present embodiment will be described below with reference to FIGS. 5 to 7.

FIG. 5 is a sequence diagram for explaining the operation of the information processing system 1 when the external power supply 50 is connected to the control device 3 and the USB device 4 is connected to the control device 3.

First, in a step S1, the external power supply 50 is connected to the first power supply section 47 of the control device 3 and thereby power is supplied from this external power supply 50 to the control device 3. Next, in a step S2, the USB cable 5b is connected to the second USB connector 362 and thereby the USB device 4 is connected to the control device 3. The connection of the USB device 4 to the control device 3 is detected by the USB hub section 360 in a step S3.

Subsequently, in a step S4, the USB hub section 360 sends out a configuration request to the USB device 4. This configuration request includes the Get_Descriptor command and therefore includes also a notification of a request for the maximum current value necessary for the USB device 4. In response to the configuration request sent out from the control device 3, the USB device 4 returns a configuration response in a step S5. This configuration response includes the maximum current value of power supplied from the wireless communication device 2 as host apparatus, declared and requested by the USB device 4. The USB device 4 is e.g. a portable HDD in one aspect of the present embodiment. Therefore, suppose that the maximum current value requested by the USB device 4 is the maximum current value as the upper limit allowed in the USB 2.0 standard, specifically 500 mA as one example, or a value close to it. The control device 3 temporarily stores, in the table 45, the maximum current value included in the configuration response received in the step S5.

In a step S6, the detecting section 46 of the control device 3 detects that power is supplied from the external power supply 50 to the first power supply section 47 and notifies the maximum current value declarer 44 of this. In addition, the switch section 342 of the control device 3 switches the power for driving the whole of the control device 3 to power supplied to the power supply connector 341. That is, from then on, the control device 3 operates as a self-powered device. Either the operation of the step S6 or the operation of the steps S3 and S4 may be executed first. Furthermore, although the USB device 4 is connected after the connection of the external power supply 50 in FIG. 5, either the external power supply 50 or the USB device 4 may be connected first. If the USB device 4 is connected prior to the connection of the external power supply 50, the operation of the steps S3 to S5 is carried out first. Then, upon the connection of the external power supply 50 (step S1), the power supply detection operation shown in the step S6 is carried out.

Subsequently, in step S7, based on the detection of supply of power from the external power supply 50 to the first power supply section 47 by the detecting section 46 in the step S6, the maximum current value declarer 44 of the control device 3 rewrites the maximum current value stored in the table 45 to the prescribed maximum current value (200 mA, in one aspect of the present embodiment) considered as a value with which a connection is permitted in the connection determiner 40 of the wireless communication device 2.

Next, in a step S8, the first external interface 43 is connected to the second external interface 41 by the USB cable 5a. This connects the control device 3 (and the USB device 4 connected to the control device 3) to the wireless communication device 2.

In a step S9, the second external interface 41 of the wireless communication device 2 detects the control device 3 (and the USB device 4 connected to the control device 3). Subsequently, in a step S10, the connection determiner 40 of the wireless communication device 2 sends out a configuration request to the control device 3. This configuration request includes the Get_Descriptor command and this Get_Descriptor command includes also a notification of a request for the maximum current value necessary for the control device 3 (and the USB device 4 connected to the control device 3). In response to the configuration request sent out from the wireless communication device 2, the maximum current value declarer 44 of the control device 3 refers to the table 45 and returns a configuration response in a step S11. This configuration response includes the maximum current value of power required to be supplied from the wireless communication device 2 as the host apparatus, declared and requested by the control device 3 (and the USB device 4 connected to the control device 3). This maximum current value is the prescribed maximum current value considered as a value with which a connection is permitted in the connection determiner 40 of the wireless communication device 2 as described above.

In a step S12, the connection determiner 40 of the wireless communication device 2, which has received the configuration response in the step S11, refers to the maximum current value included in this configuration response and determines whether or not to permit a connection of the control device 3 (and the USB device 4 connected to the control device 3). In the present embodiment, the maximum current value declared and requested from the control device 3 is equal to the prescribed maximum current value. Thus, a connection is permitted and the control device 3 (and the USB device 4 connected to the control device 3) is mounted.

Because the control device 3 (and the USB device 4 connected to the control device 3) is mounted in the step S12, from then on, a data writing/reading command is issued from the wireless communication device 2 to the USB device 4 in a step S13. In response to this, read data or a data writing success response is sent out from the USB device 4 to the wireless communication device 2 in a step S14.

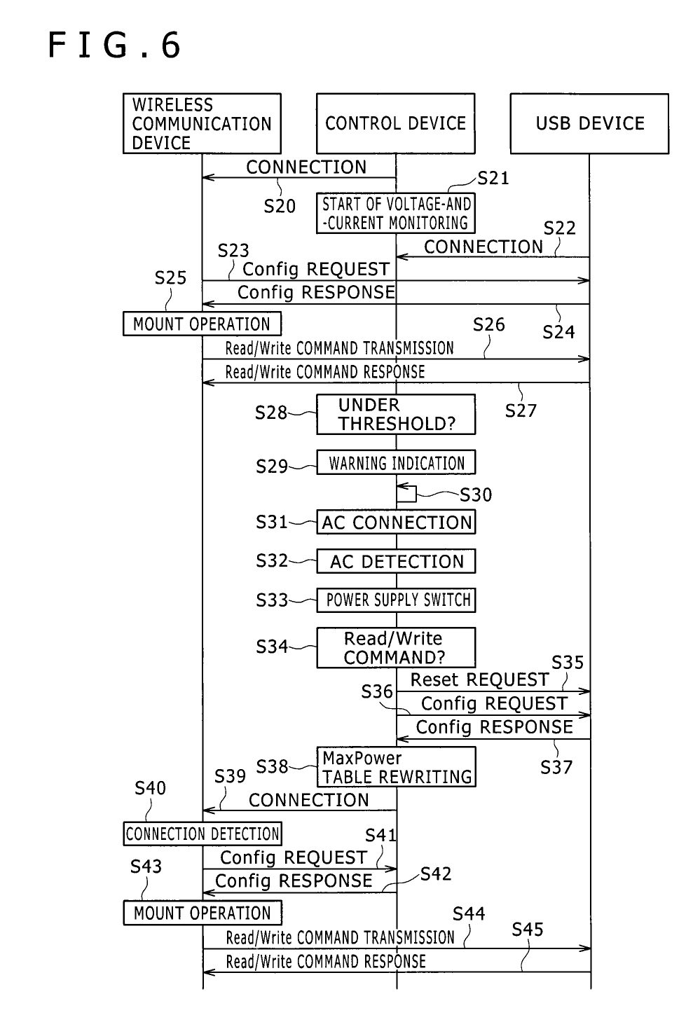

FIG. 6 is a sequence diagram for explaining the operation of the information processing system 1 when the external power supply 50 is not connected to the control device 3, i.e. the control device 3 is bus-power-driven, and the USB device 4 is connected to the control device 3.

First, in a step S20, the first external interface 43 is connected to the second external interface 41 by the USB cable 5a and thereby the control device 3 is connected to the wireless communication device 2. Subsequently, in a step S21, the voltage-and-current monitoring section 35 of the control device 3 starts to monitor the voltage and current of the power supplied from the wireless communication device 2 via the first external interface 43.

Next, in a step S22, the USB cable 5b is connected to the second USB connector 362 and thereby the USB device 4 is connected to the control device 3. Upon detecting the connection of the USB device 4 to the control device 3 in the step S22, the connection determiner 40 of the wireless communication device 2 sends out a configuration request to the control device 3 in a step S23. This configuration request includes the Get_Descriptor command and therefore includes also a notification of a request for the maximum current value necessary for the control device 3 (and the USB device 4 connected to the control device 3). Because the control device 3 operates as a bus-powered device, the USB hub section 360 of the control device 3 sends out, to the USB device 4, the configuration request sent out from the wireless communication device 2 as it is. In response to the configuration request sent out from the wireless communication device 2, the USB device 4 returns a configuration response in a step S24. This configuration response includes the maximum current value of power supplied from the wireless communication device 2 as the host apparatus, declared and requested by the USB device 4. Because the control device 3 operates as a bus-powered device, the USB hub section 360 of the control device 3 sends out, to the wireless communication device 2, the configuration response sent out from the USB device 4 as it is.

In a step S25, the connection determiner 40 of the wireless communication device 2, which has received the configuration response in the step S24, refers to the maximum current value included in this configuration response and determines whether or not to permit a connection of the control device 3 (and the USB device 4 connected to the control device 3). In one aspect of the present embodiment, the maximum current value declared and requested from the USB device 4 is larger than the prescribed maximum current value. Thus, a connection is not permitted and the control device 3 (and the USB device 4 connected to the control device 3) is not mounted in the step S25.

If the USB device 4 is a device whose maximum current value declared and requested is equal to or smaller than the prescribed maximum current value, specifically e.g. a USB flash memory, a connection is permitted in the step S25. From then on, a data writing/reading command is issued from the wireless communication device 2 to the USB device 4 in a step S26. In response to this, read data or a data writing success response is sent out from the USB device 4 to the wireless communication device 2 in a step S27.

Subsequently (this timing does not have to be immediately after the step S27), if it is detected by the voltage-and-current monitoring section 35 in a step S28 that at least one of the voltage and current of the power supplied from the wireless communication device 2 to the control device 3 has fallen below a threshold due to the decrease in the remaining power level of the internal power supply 27 of the wireless communication device 2 as a result of supply of power from the wireless communication device 2 to the control device 3 because of bus-power-driving of the control device 3, the CPU 30 of the control device 3 makes the liquid crystal panel 331 indicate a warning against the lowering of the voltage or current via the liquid crystal driver 330 in a step S29. This threshold is a value indicating that the remaining power level of the internal power supply 27 of the wireless communication device 2 has reached 10% of the full power level as one example.

In a step S30, the control device 3 waits for a connection of the external power supply 50 to the control device 3 by the user. In a step S31, the external power supply 50 is connected to the first power supply section 47 of the control device 3. Thereupon, in a step S32, the detecting section 46 of the control device 3 detects that power is supplied from the external power supply 50 to the first power supply section 47, and notifies the maximum current value declarer 44 of this. In addition, in a step S33, the switch section 342 of the control device 3 switches the power for driving the whole of the control device 3 to power supplied to the power supply connector 341. That is, from then on, the control device 3 operates as a self-powered device.

In a step S34, the CPU 30 and the USB hub section 360 of the control device 3 monitor whether a data writing/reading command is issued from the wireless communication device 2 to the USB device 4 via the second external interface 41 and the first external interface 43 and wait for a predetermined time, specifically e.g. for one minute. If determining that the data writing/reading command is not issued in this waiting time, the CPU 30 and the USB hub section 360 of the control device 3 send out a reset request to the USB device 4 in a step S35.

Thereafter, in steps S36 to S45, the same operation as that of the steps S4 and S5 and the steps S7 to S14 in FIG. 5 is carried out to thereby mount the USB device 4 to the wireless communication device 2 again and perform data transmission and reception between this wireless communication device 2 and the USB device 4.

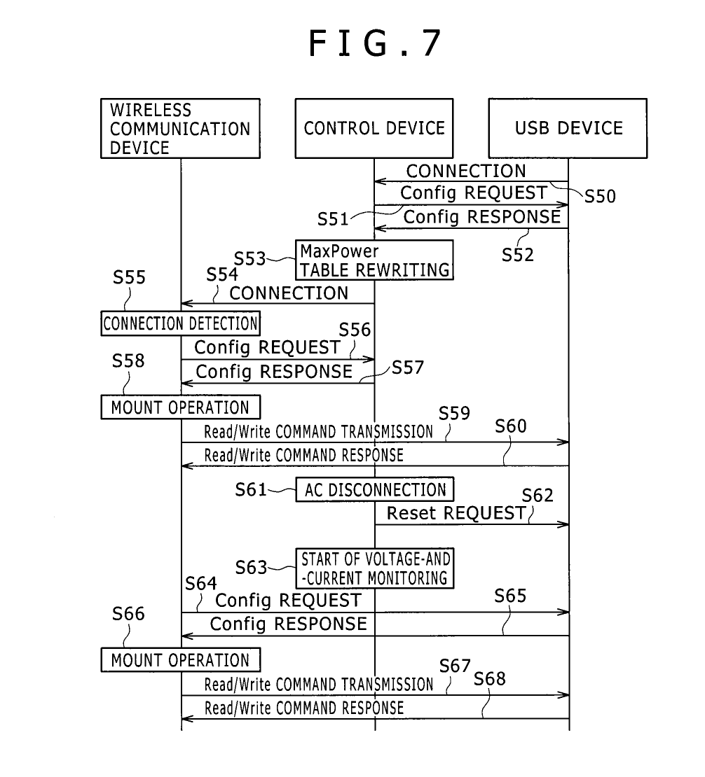

FIG. 7 is a sequence diagram for explaining the operation of the information processing system 1 when the external power supply 50 is connected to the control device 3 and the connection between the external power supply 50 and the control device 3 is disconnected after the USB device 4 is connected to the control device 3.

First, in steps S50 to S60, the same operation as that of the step S2, the steps S4 and S5, and the steps S7 to S14 in FIG. 5 is carried out to thereby mount the USB device 4 to the wireless communication device 2 and perform data transmission and reception between these wireless communication device 2 and USB device 4. At this time, the USB device 4 can be smoothly mounted by declaring the maximum current value equal to the prescribed maximum current value to the wireless communication device 2.

Subsequently, in a step S61, the supply of power from the external power supply 50 to the control device 3 is suddenly disconnected due to the occurrence of e.g. a situation in which the power supply cable 6a of the AC adapter 6 is pulled out from the control device 3 by an unintended action of the user. This power supply disconnection is detected by the detecting section 46 of the control device 3 and the detecting section 46 notifies the maximum current value declarer 44 of this. In addition, the switch section 342 of the control device 3 switches the power for driving the whole of the control device 3 to power supplied from the first external interface 43. That is, from then on, the control device 3 operates as a bus-powered device.

The occurrence of the sudden power supply disconnection switches the control device 3 from a self-powered device to a bus-powered device. However, through only this switching operation, the maximum current value declared to the wireless communication device 2 is not changed yet. In this case, the USB device 4 also operates as a bus-powered device. However, possibly the USB device 4 does not recognize that the control device 3 has been switched from a self-powered device to a bus-powered device but recognizes the control device 3 as a self-powered device to request a large current in this state. Therefore, in a step S62, the CPU 30 and the USB hub section 360 of the control device 3 send out a reset request to the USB device 4 to prompt the information processing system 1 including the wireless communication device 2 and the USB device 4 to carry out configuration operation and mount operation including re-declaration of the maximum current value.

Then, in steps S63 to S66, the same operation as that of the step S21 and the steps S23 to S25 in FIG. 6 is carried out and thereby the wireless communication device 2 and the USB device 4 carry out configuration operation and mount operation including re-declaration of the maximum current value. In the present embodiment, the maximum current value declared and requested from the USB device 4 is larger than the prescribed maximum current value. Therefore, similarly to the step S25 in FIG. 6, a connection is not permitted and the control device 3 (and the USB device 4 connected to the control device 3) is not mounted in a step S66.

If the USB device 4 is a device whose maximum current value declared and requested is equal to or smaller than the prescribed maximum current value, specifically e.g. a USB flash memory, a connection is permitted in the step S66. From then on, a data writing/reading command is issued from the wireless communication device 2 to the USB device 4 in a step S67. In response to this, read data or a data writing success response is sent out from the USB device 4 to the wireless communication device 2 in a step S68.

Therefore, according to the information processing system 1 of one aspect of the present embodiment, when the control device 3 is operating as a self-powered device, the maximum current value declarer 44 of the control device 3 declares the maximum current value equal to the prescribed maximum current value defined by the wireless communication device 2 instead of the maximum current value declared by the USB device 4. Thus, the connection determiner 40 of the wireless communication device 2 permits a connection of this control device 3 (and the USB device 4 connected to the control device 3) based on the maximum current value declared by the maximum current value declarer 44 of the control device 3. Due to this, even the USB device 4 that needs a current larger than the prescribed maximum current value can be surely connected to the wireless communication device 2.

When the control device 3 is operating as a self-powered device, sufficient power can be supplied from the control device 3 to the USB device 4 even if the USB device 4 is a device that needs a current larger than the prescribed maximum current value. Therefore, if the wireless communication device 2 permits a connection, the USB device 4 can be operated without imposing a burden on the wireless communication device 2 (particularly the internal power supply 27 of the wireless communication device 2) even if the USB device 4 is a device that needs a current larger than the prescribed maximum current value. Thus, a connection of the control device 3 (and the USB device 4 connected to the control device 3) can be surely made through declaration of the maximum current value equal to the prescribed maximum current value, with and under which the connection is permitted, by the maximum current value declarer 44 of the control device 3 when the control device 3 is connected to the wireless communication device 2.

As a result, even to the wireless communication device 2 such as a smartphone having a difficulty in continuing supply of power with a large current for a long time, the USB device 4 that needs a large current in driving, such as a portable HDD, can be surely connected via the control device 3. This can further enhance the convenience of the wireless communication device 2.

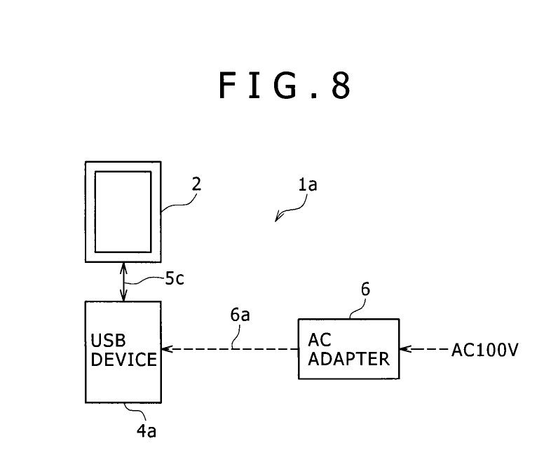

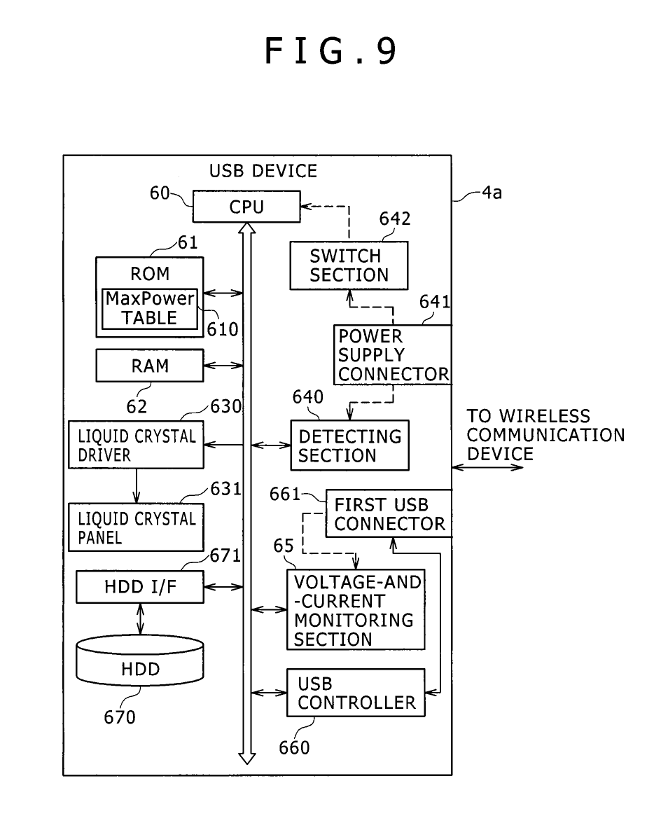

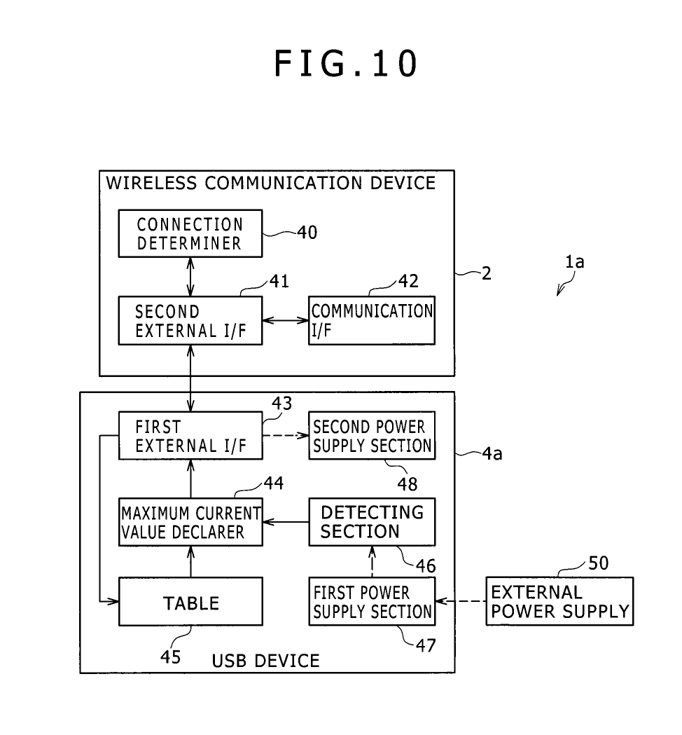

FIG. 8 is a schematic diagram showing the outline of an information processing system according to another aspect of the embodiment of the present disclosure. FIG. 9 is a block diagram showing the schematic configuration of a USB device used for the information processing system according to another aspect of the present embodiment. FIG. 10 is a functional block diagram showing the functional configuration of the information processing system according to another aspect of the present embodiment.

An information processing system 1a according to another aspect of the present embodiment shown in FIG. 8 is different from the information processing system 1 according to one aspect of the present embodiment shown in FIG. 1 in that a USB device (external apparatus) 4a is connected directly to the wireless communication device 2 via a USB cable 5c. Therefore, the same constituent element is given the same numeral and description thereof will be simply made.

### Schematic Configuration of USB Device

The USB device 4a of the present embodiment shown in FIG. 9 includes a CPU 60, a ROM 61 (including a MaxPower table 610), a RAM 62, a liquid crystal driver 630, a liquid crystal panel 631, a detecting section 640, a power supply connector 641, a switch section 642, a voltage-and-current monitoring section 65, and a first USB connector 661. They are almost the same as the CPU 30, the ROM 31, the RAM 32, the liquid crystal driver 330, the liquid crystal panel 331, the detecting section 340, the power supply connector 341, the switch section 342, the voltage-and-current monitoring section 35, and the first USB connector 361 configuring the control device 3 according to one aspect of the present embodiment shown in FIG. 3. The differences between the configurations of FIGS. 3 and 9 are as follows. The USB device 4a includes a HDD 670 and a HDD interface 671 because being also a portable HDD as with the USB device 4 according to one aspect of the present embodiment. Furthermore, the USB device 4a according to another aspect of the present embodiment does not have a hub function. Therefore, the second USB connector 362 according to one aspect of the present embodiment is omitted and a USB controller 660 is provided instead of the USB hub section 360. Suppose that the maximum current value requested by the USB device 4a according to another aspect of the present embodiment is the maximum current value as the upper limit allowed in the USB 2.0 standard, specifically 500 mA as one example, or a value close to it.

### Functional Configuration of Information Processing System

FIG. 10 is a functional block diagram showing the functional configuration of the information processing system 1a according to another aspect of the present embodiment. The difference between the information processing system 1a according to another aspect of the present embodiment and the information processing system 1 according to one aspect is that the USB device (external apparatus) 4a is connected directly to the wireless communication device 2 as described above. Therefore, there is no difference in the functional configuration of the wireless communication device 2 configuring the information processing system 1a. Furthermore, the USB device 4a configuring the information processing system 1a includes the first external interface 43, the maximum current value declarer 44, the table 45, the detecting section 46, the first power supply section 47, and the second power supply section 48.

In the above-described functional configuration, the connection determiner 40 is configured mainly by the CPU 20. The second external interface 41 is configured mainly by the CPU 20 and the USB controller 260. The communication interface 42 is configured mainly by the CPU 20 and the mobile communication module 240. The first external interface 43 is configured mainly by the CPU 60 and the first USB connector 661. The maximum current value declarer 44 is configured mainly by the CPU 60. The table 45 is configured mainly by the MaxPower table 610 of the ROM 61. The detecting section 46 is configured mainly by the CPU 60 and the detecting section 640. The first power supply section 47 is configured mainly by the power supply connector 641. The second power supply section 48 is configured mainly by the first USB connector 661. The external power supply 50 is configured mainly by the AC adapter 6.

Therefore, the USB device 4a according to another aspect of the present embodiment is capable of operation similar to that of the control device 3 according to one aspect of the present embodiment. Thus, similarly to the control device 3 according to one aspect of the present embodiment, the USB device 4a can provide an effect that even the USB device 4a requiring a current larger than the prescribed maximum current value can be surely connected to the wireless communication device 2.

Details of the information processing system and the control device of the present disclosure are not limited to the above-described embodiment and various modification examples are possible.

As one example, the maximum current value declarer 44 of the control device 3 according to one aspect of the present embodiment declares the maximum current value equal to the prescribed maximum current value defined by the connection determiner 40 of the wireless communication device 2 to thereby obtain connection permission by the connection determiner 40. However, as long as the maximum current value declarer 44 declares a maximum current value equal to or smaller than the prescribed maximum current value defined by the wireless communication device 2 (particularly the connection determiner 40), the control device 3 (and the USB device 4 connected to the control device 3) can be surely connected to the wireless communication device 2. In particular, because it is difficult for the control device 3 to know the prescribed maximum current value defined by the wireless communication device 2 in advance, the maximum current value declarer 44 may presume the prescribed maximum current value defined in the general wireless communication device 2 and declare a maximum current value lower than the prescribed maximum current value presumed (e.g. 100 mA, in an example according to one aspect of the present embodiment) in expectation of a certain margin.

Moreover, if the connection determiner 40 of the wireless communication device 2 does not permit a connection (deny mounting), the maximum current value declarer 44 may re-declare a maximum current value lower than the declared maximum current value to further ensure a connection to the wireless communication device 2. It is impossible for the control device 3 to know whether the connection determiner 40 of the wireless communication device 2 did not permit a connection, in the state in which a connection has not been permitted. Therefore, the maximum current value declarer 44 waits for a certain time after declaration of the maximum current value. If a data writing/reading command is not sent out from the wireless communication device 2 in this waiting time, the maximum current value declarer 44 determines that the connection determiner 40 of the wireless communication device 2 did not permit a connection and re-declares a maximum current value lower than the declared maximum current value. Then, the maximum current value declarer 44 declares a smaller maximum current value until the data writing/reading command is sent out from the wireless communication device 2.

In addition, a table storing the prescribed maximum current value of each host apparatus may be provided in external apparatus and the external apparatus may detect the manufacturer name (vendor ID) and the product name (product ID) of host apparatus in e.g. configuration operation. This allows the maximum current value declarer to refer to this table to declare a maximum current value appropriate for the host apparatus (i.e. maximum current value equal to or smaller than the prescribed maximum current value defined on each host apparatus basis). Examples of the method for detecting the manufacturer name and the product name of host apparatus include a method in which, in the above-described one aspect of the present embodiment, the USB controller 260 and the USB hub section 360 are so operated that the control device 3 operates as a USB host and the wireless communication device 2 operates as a USB device when the control device 3 is USB-connected to the wireless communication device 2. If the control device 3 transmits the Get_Descriptor command in this state, the wireless communication device 2 returns a response including vendor ID and product ID in response to this. This allows the control device 3 to detect the vendor ID and product ID of the wireless communication device 2. Furthermore, the prescribed maximum current value of each wireless communication device 2 is stored in the MaxPower table 310. In addition, the control device 3 stores the vendor ID and the product ID included in the response from the wireless communication device 2 in e.g. the ROM 31 and refers to this vendor ID and product ID in declaration of a maximum current value. Thereby, a maximum current value appropriate for the wireless communication device 2 can be declared. This can make the connection between the external apparatus and the host apparatus more surely. Alternatively, the maximum current value with which a connection is permitted by the wireless communication device 2 in the above-described manner may be stored in e.g. the MaxPower table 310 of the ROM 31 together with the vendor ID and product ID of the wireless communication device 2, and the control device 3 may refer to the MaxPower table 310 to declare the same maximum current value as that of the previous time when the control device 3 is connected to the wireless communication device 2 again after the connection to the wireless communication device 2 is disconnected. That is, the control device 3 may learn the maximum current value.

Moreover, it is also possible to prepare a server having a table in which the prescribed maximum current value of each host apparatus is stored on an external network such as the Internet and update this table every time new host apparatus appears. Furthermore, when host apparatus is connected to external apparatus, a table of the external apparatus may be updated through a connection to the server via a communication interface possessed by the host apparatus. This can make the connection between the external apparatus and the host apparatus more surely. As one example, the maximum current value declarer 44 of the control device 3 may access the server to update the MaxPower table 310 via the communication interface 42 possessed by the wireless communication device 2 according to one aspect of the present embodiment and a mobile communication network.

In the above-described embodiment, whether external power supply is present or absent is automatically determined by the detecting section 46. However, a switch for power supply switching may be provided in external apparatus and the maximum current value declarer 44 may determine whether or not to declare a maximum current value equal to or smaller than the prescribed maximum current value depending on the position of this switch for power supply switching. As one example, in the control device 3 according to one aspect of the present embodiment, a switch for power supply switching may be provided instead of the detecting section 340 and the switch section 342 and whether the control device 3 will operate as a bus-powered device or operate as a self-powered device may be determined based on the position of this switch for power supply switching. In addition, the maximum current value declarer 44 may also determine whether or not to declare a maximum current value equal to or smaller than the prescribed maximum current value depending on the position of this switch for power supply switching. Furthermore, in the above-described embodiment, the maximum current value declarer 44 decides the maximum current value that should be declared to the wireless communication device 2 with reference to the MaxPower table 310. However, a slide switch for maximum current value switching having slide positions to which different maximum current values (100 mA, 200 mA, etc.) are assigned may be provided in e.g. the control device 3 and the maximum current value that should be declared by the maximum current value declarer 44 may be set based on the slide position of this slide switch.

In the above-described embodiment, when the control device 3 or the USB device 4a is operating as a bus-powered device, warning indication is made by using the liquid crystal panel 331 or 631 if the value of the voltage or current supplied from the wireless communication device 2 has fallen below a predetermined value. However, the warning indication to the user is not limited to that by the liquid crystal panel 331 or 631. There is no particular limitation as long as a measure capable of informing the user of the lowering of the voltage or current value is employed. Examples of the measure include blinking of a light emitting diode (LED), change of the lighting color of an LED e.g. from green to red, and buzzer sounding.

In the above-described embodiment, the control device 3 and the USB device 4a are driven by supply of power from an external power supply or the wireless communication device 2. However, a configuration may be employed in which the control device 3 is driven by supply of power from a battery (internal power supply) such as a secondary cell. If power is supplied from a battery, the control device 3 and the USB device 4a operate as a self-powered device. At this time, for example the operation at the start of the sequence diagram shown in FIG. 6 and the step S61 in the sequence diagram shown in FIG. 7 include operation carried out when the remaining capacity of the battery in the control device 3 falls below the level at and over which the control device 3 can operate as a self-powered device. Furthermore, the step S6 in the sequence diagram shown in FIG. 5 and the step S32 in the sequence diagram shown in FIG. 6 include operation carried out when the remaining capacity of the battery in the control device 3 surpasses the level at and over which the control device 3 can operate as a self-powered device.

In one aspect of the above-described embodiment, if the control device 3 and the USB device 4 have individually-needed maximum current values, the value obtained by adding the maximum current values of the control device 3 and the USB device 4 to each other may be returned in response to the Get_Descriptor request from the wireless communication device 2.

Although the USB devices 4 and 4a are portable HDDs in the above-described embodiment, they are not limited thereto and may be apparatus well-known as a USB device, specifically a USB flash memory or a wireless LAN adapter as one example.

What is claimed is:

1. An information processing apparatus comprising:
a first external interface configured to be connected to a host apparatus;
a first power supply section configured to be connected to an external power supply;
a second power supply section configured to receive power via the first external interface; and
circuitry configured to
detect whether power is received at the first power supply section; and
declare, to the host apparatus, a maximum current value equal to or smaller than a prescribed maximum current value defined by the host apparatus when the information processing apparatus is connected to the host apparatus via the first external interface and it is detected that power is received at the first power supply section.

2. The information processing apparatus according to claim 1, further comprising
a second external interface configured to connect to a peripheral apparatus, wherein
the peripheral apparatus is supplied with power via the third external interface.

3. The information processing apparatus according to claim 2, wherein the circuitry is configured to declare, to the host apparatus, a maximum current value declared by the peripheral apparatus if it is not detected that power is supplied via the first power supply section.

4. The information processing apparatus according to claim 1, wherein
the information processing apparatus operates by consuming current of a current value equal to or larger than the declared maximum current value if it is detected that power is received at the first power supply section.

5. The information processing apparatus according to claim 1, wherein
the circuitry is configured to re-declare a value smaller than the declared maximum current value as a maximum current value if the host apparatus does not permit a connection based on the declared maximum current value.

6. The information processing apparatus according to claim 1, further comprising:
a table configured to store a prescribed maximum current value corresponding to the host apparatus.

7. The information processing apparatus according to claim 6, wherein
the circuitry refers to the table to declare, to the host apparatus, the maximum current value equal to or smaller than the prescribed maximum current value corresponding to the host apparatus if it is detected that power is received via the first power supply section.

8. The information processing apparatus according to claim 6, wherein
the circuitry updates the table based on information received via the first external interface when the information processing apparatus is connected to the host apparatus via the first external interface.

9. An information processing method performed by an information processing apparatus including a first external interface configured to be connected to a host apparatus, a first power supply section configured to be connected to an external power supply and a second power supply section configured to receive power via the first external interface, the method comprising:
detecting, by circuitry of the information processing apparatus, whether power is received at the first power supply section; and
declaring, to the host apparatus, a maximum current value equal to or smaller than a prescribed maximum current value defined by the host apparatus when the information processing apparatus is connected to the host apparatus via the first external interface and it is detected that power is received at the first power supply section.

10. An information processing system comprising:
an external apparatus having a first external interface; and
a host apparatus configured to perform data transmission and reception and supply power to the external apparatus via a second external interface configured to be connected to the first external interface of the external apparatus, wherein
the external apparatus includes
a first power supply section configured to be connected to an external power supply;
a second power supply section configured to receive power via the first external interface; and
first circuitry configured to
detect whether power is received at the first power supply section; and
declare, to the host apparatus, a maximum current value equal to or smaller than a prescribed maximum current value defined by the host apparatus when the information processing apparatus is connected to the host apparatus via the first external interface and it is detected that power is supplied via the first power supply section, and
the host apparatus includes second circuitry configured to not permit a connection via the second external interface if the maximum current value declared from the external apparatus is greater than a prescribed maximum current value corresponding to the host apparatus.

11. The information processing system according to claim 10, wherein
the external apparatus operates by consuming current of a current value equal to or larger than the declared maximum current value via the first external interface if it is detected that power is received at the first power supply section.

12. The information processing system according to claim 10, wherein
the first circuitry is configured to re-declare a value smaller than the declared maximum current value as a maximum current value if the host apparatus does not permit a connection via the second external interface based on the declared maximum current value.

13. The information processing system according to claim 10, wherein
the external apparatus includes a table configured to store the prescribed maximum current value corresponding to the host apparatus.

14. The information processing system according to claim 13, wherein
the first circuitry refers to the table to declare, to the host apparatus, the maximum current value equal to or smaller than the prescribed maximum current value corresponding to the host apparatus if it is detected that power is received via the first power supply section.

15. The information processing system according to claim 13, wherein
the host apparatus includes a communication interface, and
the first circuitry updates the table based on information received via the communication interface when the external apparatus is connected to the host apparatus via the first external interface.
